(19) United States
(12) Patent Application Publication
(10) Pub. No.: US 2014/0076291 A1
(43) Pub. Date: Mar. 20, 2014

(54) METHOD AND APPARATUS FOR CONTROLLING PREMIXED COMBUSTION IN A MULTIMODE ENGINE

(71) Applicant: Hoi Ching Wong, San Diego, CA (US)

(72) Inventor: Hoi Ching Wong, San Diego, CA (US)

(73) Assignee: Clean Air Power, Inc, Poway, CA (US)

(21) Appl. No.: 14/115,472

(22) PCT Filed: Jul. 30, 2012
(86) PCT No.: PCT/US12/48770

§ 371 Date: Nov. 4, 2013

Related U.S. Application Data
(60) Provisional application No. 61/521,414, filed on Aug. 9, 2011.

(51) Int. Cl. F02M 25/07

(52) U.S. Cl. CPC F02M 25/0715
USPC 123/568.11

(57) ABSTRACT

A method of fueling an internal combustion engine including operating the internal combustion engine in a dual-fuel mode in which the engine is fueled by a pre-mixed charge of fresh air, recirculated exhaust gases, gaseous fuel as primary fuel and early injected liquid fuel as a secondary fuel, ignited by a late injected pilot fuel to provide low temperature combustion. The method further includes adjusting EGR and/or fresh airflow to the engine to maintain peak in-cylinder temperature in a desired range, preferably between 1500 K and 2000 K. EGR preferably is controlled to obtain a desired in-cylinder O₂ mole fraction, and fresh airflow preferably is controlled to obtain a desired fresh air lambda.

### CROSS REFERENCE TO A RELATED APPLICATION

This application claims the benefit of U.S. Provisional Application Ser. No. 61/521,414; filed Aug. 9, 2011, the contents of which are hereby incorporated by reference in their entirety.

### BACKGROUND OF THE INVENTION

1. Field of the Invention

This invention relates generally to multimode engines capable of operating in multiple fueling modes, and more particularly, relates to a method and apparatus for minimizing emissions through control of in-cylinder O₂ concentration and fresh air λ to achieve low temperature combustion.

2. Discussion of the Related Art

Traditional internal combustion engine concepts such as diesel compression ignition and gasoline spark ignition require trade-offs between various emissions including Nitrogen Oxides (NOₓ), Particulate matter (soot), carbon monoxide (CO), and Hydrocarbons (HC). These emissions technically had to be balanced against maintaining engine efficiency and fuel economy.

Homogeneous charge compression ignition (HCCI) has been developed to at least partially overcome the requirement for these trade-offs. HCCI is a form of internal combustion in which a well-mixed charge of finely atomized fuel and an oxidizer are compression-ignited. The oxidizer is typically air, so the term “air” and “oxidizer” will be used interchangeably herein. When compared to traditional compression ignition (CI) engines, HCCI is characterized by the introduction, of the fuel much earlier in the compression stroke than was traditionally the case in Cl engines so that the fuel can be thoroughly mixed with air prior to auto-ignition. Ignition occurs simultaneously throughout the cylinder when compression brings the mixture to its auto-ignition temperature.

The charge may be diluted by being very lean, by mixing with EGR, or a combination of the two Because the charge is very dilute, very low combustion temperatures can be achieved, and NOx emissions are reduced. Particulate emissions are also very low because the premixed charge is lean, or at most, is a stochiometric mixture.

HCCI, or variations of it, such as premixed charge compression ignition (PCCI), may be used in a “multimode” engine capable of operating in multiple fueling modes in that they are powered by different fuels or combinations of fuels depending, e.g., on the prevailing engine speed and load conditions. For example, in a pilot mode, the engine may be fueled primarily by a gaseous fuel, such as natural gas or propane, which is ignited by a relatively small quantity or “pilot” charge of a liquid fuel, typically diesel fuel or engine lube oil. Diesel quantity of 2% (by energy) has been proven adequate for pilot-ignited natural gas engine operation. Combustion in such an engine is a mix of classical diesel compression ignition and gasoline spark ignition, where diesel fuel is auto-ignited by compression temperature. In a PCCI pilot mode engine, the charge of gaseous fuel, and air typically is admitted during the intake stroke, while diesel fuel is admitted at about 60° to 70° BTDC. Low NOx and low soot emissions can be simultaneously achieved in dual fuel engines if combustion takes place under homogeneous or very low stratified conditions. The initial heat release rate in such engines is primarily influenced by fuel properties, conditions in the cylinder prior to injection, and their interaction with the pilot fuel spray. Ideally, the combustion (auto-ignition) should only start when the diesel injection event is over to avoid rich or stochiometric air-fuel pockets. The desired ignition delay can be achieved by introducing EGR to sufficiently separate the end of diesel injection (EOI) and the start of the combustion (SOC).

However, with the introduction of EGR, the in-cylinder O₂ content is reduced, and combustion efficiency is not as high as that of diesel compression, resulting in increased CO and HC emissions.

Most of the HC emissions in pilot-ignited natural gas engines are in the formed unburned fuel, principally the gaseous fuel (most typically natural gas). Possible sources of these emissions are:
Unburned fuel in the cylinder crevices that escapes through the exhaust. The amount of fuel trapped in the crevices may be relatively low at lean air-fuel ratio conditions;
Quenching of the flame front close to the cylinder wall where temperatures are lower, which occurs in every engine cycle. This quenching is more pronounced under lean conditions; and
Bulk quenching of the fuel-air mixture in the event of a complete or partial misfire of a cylinder. All or at least a significant portion of the fuel-air mixture may fail to undergo combustion in this case.

Charge temperature and time available for combustion are the critical parameters affecting HC oxidation in the expansion stroke. Generally speaking, HC emissions are lower at higher air charge temperatures and longer combustion time availabilities. One way to promote low temperature combustion and to simultaneously control the combustion rate is through so-called “pilot-assisted HCCI.” Pilot-assisted HCCI engines are characterized by a PCI or other HCCI engine in which a small charge of diesel fuel of another liquid fuel capable of auto-ignition is injected late in the compression cycle, preferably at, near, or even after, TDC. The premixed charge in an engine fueled in this mode consists at least in part of air, natural gas as a primary fuel, and early injected diesel or another liquid fuel as a secondary fuel. As in many other multimode HCCI engines, EGR is used to prevent auto-ignition of the early injected diesel fuel, and to dilute the premixed fuel-air charge for low combustion temperature and slow heat release rate. In this fueling mode, the early injected liquid fuel thoroughly vaporizes and mixes with the air (including any EGR) and gaseous fuel prior to commencement of ignition. This liquid fuel quantity compensates for the energy absorbed by the CO₂ and water vapor in the recirculated EGR. The quantity of this early liquid fuel can be a function of EGR fraction, O₂ mole fraction, and/or fresh air λ. The ratio of the liquid fuel to the gaseous fuel within the premixed charge controls the combustion duration. The heat release rate is a function of O₂ mole fraction and fresh air λ.

Injection of the late injected liquid fuel charge, typically taking place at or near TDC, controls the ignition timing within the cylinder. This charge is auto-ignited by compression temperature. Its injection timing and quantity control the start of combustion of the premixed charge, within which the vaporized liquid fuel portion of the premixed charge begins combustion first due to relatively lower auto-ignition temperature. Once the vaporized liquid fuel portion of the premixed charge ignites, it provides more ignition sources for the gaseous fuel portion of the premixed charge. In effect, it acts as thousands of minuscule spark plugs that uniformly ignite the gaseous fuel in the charge.

Since combustion phasing and duration can be controlled by controlling the timing and ratio of the amount of early-injected diesel fuel to the gaseous fuel in the premixed charge, and since the percentage of the early injected fuel in the total charge and combustion phasing are dependent in part on EGR, low temperature combustion can be achieved by controlling injection timing and the mix of fuels and gases, including EGR, in the cylinder. Accordingly, controlling system inputs to provide low temperature combustion that is nevertheless hot enough to maintain combustion efficiency and low HC emissions is desired.

The need therefore exists to provide a multimode engine that facilitates control of the timing and duration of low temperature combustion in a multimode internal combustion engine. What is further needed is such an engine configured to facilitate low temperature combustion across a range of operating loads.

The need also exists to provide a method of controlling inputs to an internal combustion engine to facilitate low temperature combustion.

### SUMMARY OF THE INVENTION

In accordance with a preferred aspect of the invention, a method of fueling an internal combustion engine includes operating the internal combustion engine in a dual-fuel or other multimode in which the engine is fueled by a pre-mixed fuel-air charge ignited by an injected pilot fuel to provide low temperature combustion. The fueling method further includes controlling EGR flow and fresh air flow to maintain the peak in-cylinder temperature in a desired range, preferably of between 1500 K and 2000 K. Preferably, EGR is controlled to obtain a desired in-cylinder oxygen concentration, reflected for example by a desired O₂ mole fraction, and controlling airflow to obtain a desired fresh air λ. Fresh airflow preferably is controlled by controlling operation of at least one of a turbo wastegate, a turbo-air-bypass (TAB) valve, and a throttle valve.

Also disclosed is a system implementing a method at least as substantially described herein.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which;

FIG. 1 schematically represents a dual fuel engine constructed and controlled in accordance with a preferred embodiment of the present invention;

FIG. 2 is a partially schematic sectional side elevation view of a cylinder of the engine of FIG. 1 and of associated engine components;

FIG. 3 schematically represents an air intake control system constructed and controlled in accordance with a preferred embodiment of the present invention;

FIG. 4 is a schematic control diagram of the engine of FIGS. 1 and 2 and of its attendant controllers and sensors;

FIGS. 5A and 5B are graphs illustrating the effects of O₂ variations on various emissions;

FIGS. 6A-6D are graphs illustrating EGR-boost interaction with fresh air λ and O₂ at various engine loads;

FIGS. 7A-7D are graphs illustrating EGR-boost interaction with in-cylinder excess oxygen ratio and O₂ at various engine loads;

FIG. 8 is a flowchart illustrating a preferred computer-implemented technique for facilitating low temperature combustion in a multimode engine based on a targeted oxygen content and fresh air λ using the air intake control system of FIG. 3; and

FIGS. 9A and 9B are graphs showing the effects of O₂ variations on various emissions.

### DETAILED DESCRIPTION OF THE PREFERRED EMBODIMENTS

The low temperature combustion control concepts described herein are applicable to a variety of multimode engines in which it is desirable to maintain engine efficiency while simultaneously reducing harmful emissions. Hence, while a preferred embodiment of the invention will now be described in conjunction with a turbocharged, EGR, single point, pre-mixed charge fuel supply dual fuel engine, it is usable with tri-mode and other multimode engines as well and also with multi-point engines. For instance, it could be fueled on a single point or multi-point multi-fuel engine operating in a first mode in which the engine is fueled exclusively by a liquid first such as diesel fuel and a second mode in which a pre-mixed charge gas, such as a natural gas is ignited by a second liquid fuel, such as an early injected diesel. In a preferred embodiment, the engine is fueled in a pilot-assisted PCCI mode characterized by the early admission of a primary charge of air, EGR, natural gas, and diesel fuel or another liquid fuel, followed by the late injection of a small quantity of a liquid pilot fuel.

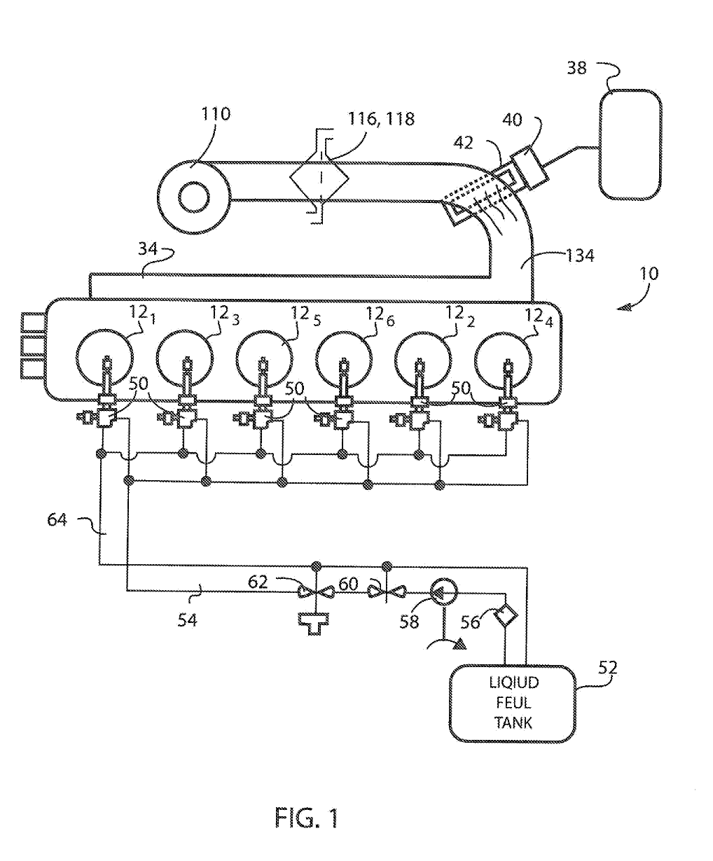

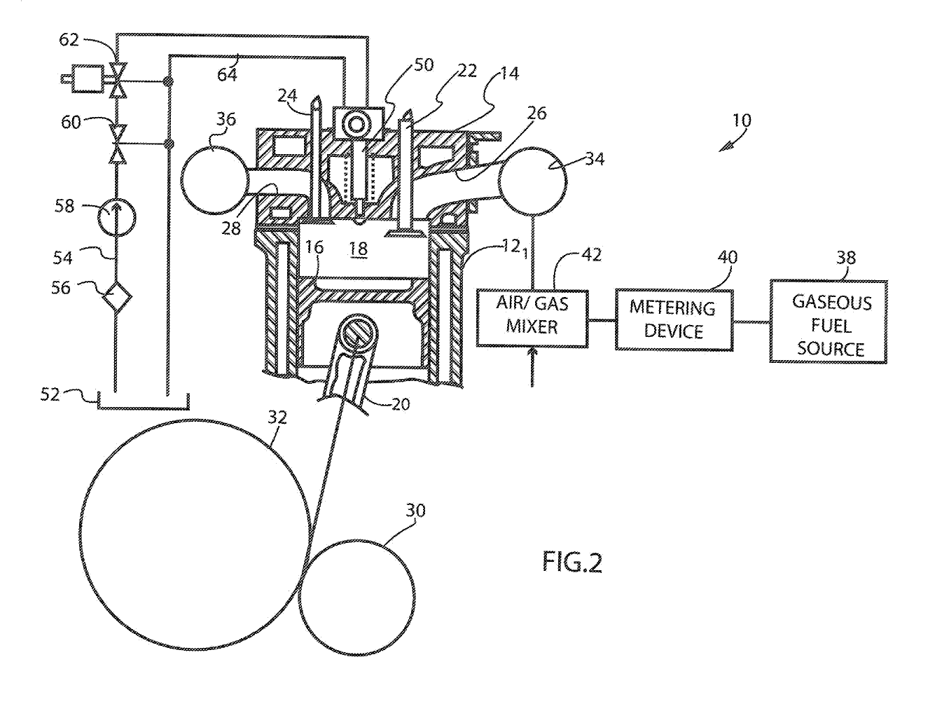

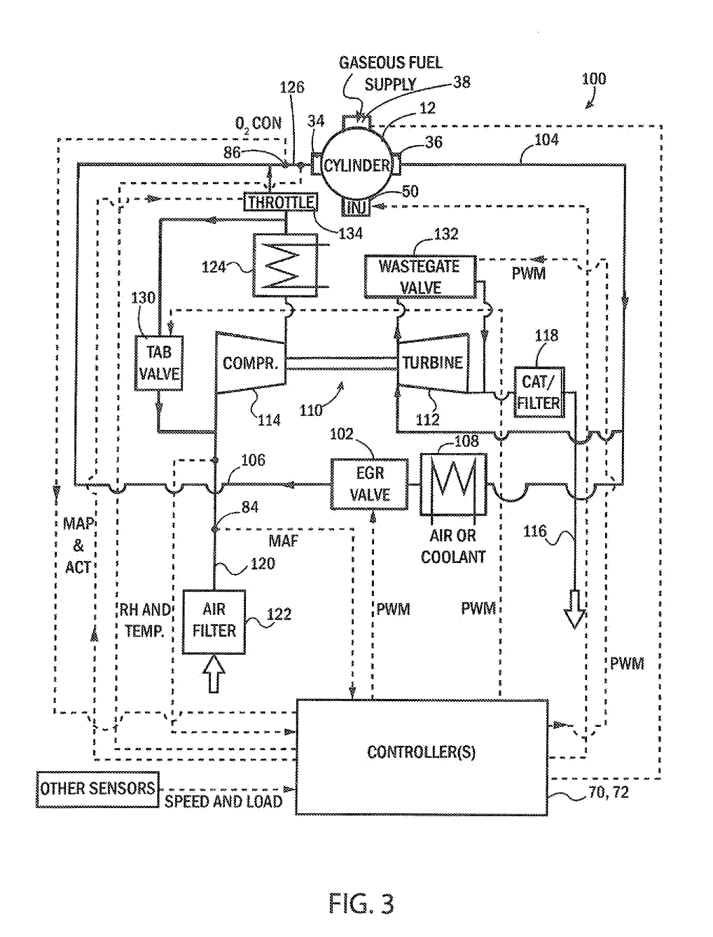

The exemplary engine 10 illustrated in FIGS. 1-2 is a compression ignition-type internal combustion engine having a plurality of cylinders 12 capped with a cylinder head 14 (FIG. 2). Six cylinders 12₁-12₆ are shown in this embodiment. As is also shown in FIG. 2, a piston 16 is slidably disposed in the bore of each cylinder to define a combustion chamber 18 between the cylinder head 14 and the piston 16. Piston 16 also is connected to a crankshaft 32 in a conventional manner. Inlet and exhaust valves 22 and 24 are provided at the end of respective passages 26 and 28 in the cylinder head 14 and are actuated by a standard camshaft 30 that is rotated by a crankshaft 32 so as to control the supply of an air/fuel mixture to, and the exhaust of combustion products from the combustion chamber 18. Gases are supplied to and exhausted from engine 10 via an air intake manifold 34 and an exhaust manifold 36 (FIG. 3), respectively.

The engine 10 also is fitted with a gaseous fuel supply system, either in an OEM or a retrofit (conversion) process. The system includes a source 38 of gaseous fuel such as a compressed natural gas (CNG) fuel tank. Other sources, such as liquefied natural gas (LNG) could also be used. The gaseous fuel may be supplied to the cylinders 12₁-12₆ from the source 38 via any suitable mechanism. For instance, one or more separate electronically actuated external injectors could be provided for each cylinder. Injectors of this type are disclosed, for example, in U.S. Pat. No. 5,673,673 and entitled Method and Apparatus for the High Mach Injection of a Gaseous Fuel into an Internal Combustion Engine, the subject matter of which is incorporated herein by reference. In the illustrated embodiment in which the gaseous fuel supply system is a single point injection system lacking dedicated injectors for each cylinder, the gaseous fuel is supplied to the intake manifold 34 via a fuel metering device 40 and an air/gas mixer 42, which also form part of the gaseous fuel supply system. The fuel metering device 40 may be any suitable electronically controlled actuator capable of supplying gaseous fuel at times and quantities demanded by a gaseous fuel controller 70 (detailed below). One suitable fuel metering device is a gas injector available from the Clean Air Power gas injector, Part No, 619625. The air/gas mixer 42 may be any suitable mixer, such as the one disclosed in U.S. Pat. No. 5,408,978 and entitled Gaseous Fuel Entrainment Device and Method, the subject matter of which is incorporated by reference. Shut off valve(s) and other equipment for controlling the flow of gas to the metering device 40, all of which are known to those skilled in the art, are omitted for the sake of convenience.

Liquid fuel could be supplied to the cylinders 12₁-12₆ via either any system capable of delivering fuel to the individual cylinders at demanded times and quantities. For example, the fuel supply system could be a pump/nozzle supply system or via a common rail supply system as described, for example, in U.S. Pat. No. 5,887,566, and entitled Gas Engine with Electronically Controlled Ignition Oil Injection, the subject matter of which is incorporated herein by reference. The illustrated engine 10 employs a pump/nozzle supply system having multiple electronically controlled liquid fuel injectors 50. Each injector could comprise any electronically controlled injector. Referring to FIGS. 1 and 2, each injector 50 is fed with diesel fuel or the like from a tank 52 via a supply line 54. Disposed in supply line 54 are a filter 56, a pump 58, a high-pressure relief valve 60, and a pressure regulator 62. A return line 64 also leads from the injectors 50 to the tank. 52.

Referring now also to FIG. 3, the air intake control system 100 for engine 10 may include (1) an exhaust gas recirculation (EGR) subsystem permitting recirculated exhaust gases to flow from the exhaust manifold 36 to the intake manifold 34 and/or (2) a turbocharger 110 which charges air admitted to the intake manifold 34. The turbocharger 110, if present, includes a turbine 112 and a compressor 114 and is driven by exhaust gases to pressurize air in the conventional manner.

The EGR subsystem has an EGR metering valve 102 located in an EGR return line 104 leading from the exhaust manifold 36 to an air intake passage 126 opening into the intake manifold 34. Valve 102 has an outlet connected to a downstream portion 106 of EGR return line 104. An EGR cooler 108 is provided in the EGR line 104 either upstream or downstream of the EGR valve 102. Exhaust gases that do not flow through the EGR valve flow through or around the turbine 112 en route to an exhaust passage 116. The exhaust in the exhaust passage 116 is treated by one or more catalysts and one or more filters (the combination of all such devices being denoted 118 in FIG. 3) before being exhausted to atmosphere.

Still referring to FIG. 3, intake air is admitted into an intake passage 120, where it is filtered in a filter 122 before being pressurized in the compressor 114 of the turbocharger. The outlet of the compressor 114 may be coupled to the inlet of a high pressure charge air cooler 124. The outlet of the high pressure charge air cooler 124 opens into the intake passage 126 downstream of the EGR valve outlet line 106.

Measures are provided to control fresh air λ through the control of fresh air flow to the intake manifold 34. In the preferred embodiment, this control may be achieved by controlling the boost of the turbocharger 110 and/or by throttling the flow of fresh air to the intake manifold 34 using the intake throttle valve 134. Turbocharger boost can be adjusted by control of a turbo air bypass valve or TAB valve 130, which bleeds boost air back to the compressor inlet of the turbocharger 110, and/or by control of a wastegate 132 on the exhaust side of the turbocharger. Airflow can be throttled through operation of a throttle valve 134 opening into the intake inlet passage 126 downstream of the EGR valve outlet.

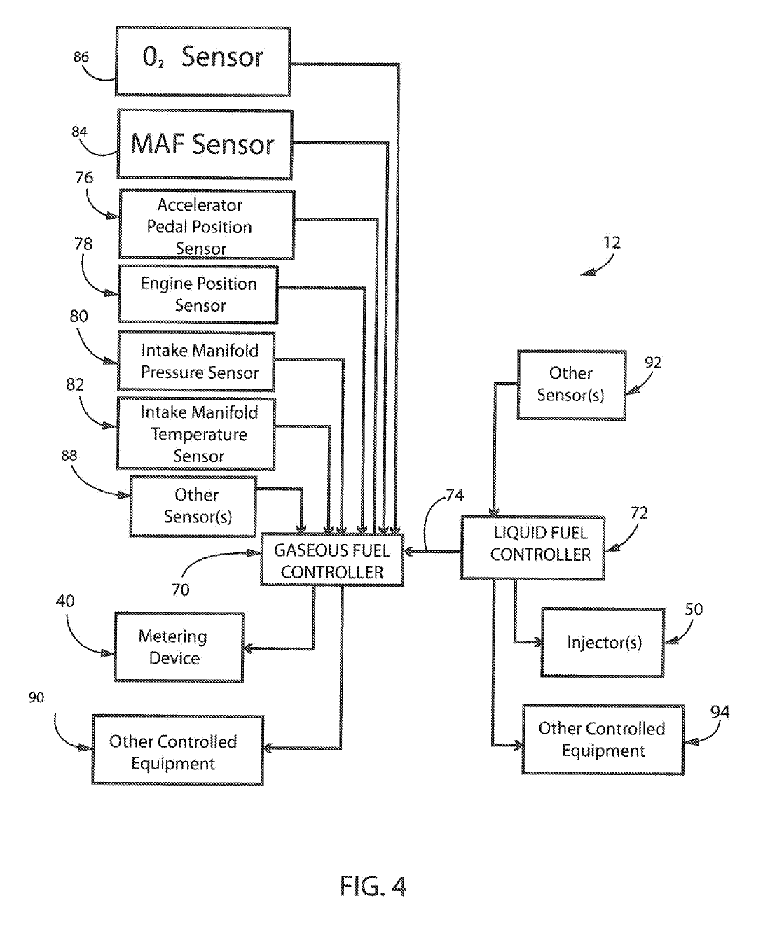

Referring to FIG. 4, the engine control system 12 may be governed either mechanically or electronically. The illustrated engine control system 12 is electronically governed. As shown in FIG. 4, engine operation is controlled by a gaseous fuel controller 70 and a liquid fuel controller 72. The controllers 70 and 72 preferably are connected to one another by a CAN link or other broadband communications link 74 for reasons discussed in more detail below. The controllers 70 and 72 receive data from an accelerator pedal position sensor 76, an engine position sensor 78, an intake manifold pressure sensor 80, and an intake manifold temperature sensor 82. (Several sensors illustrated in FIG. 4 are also denoted in FIG. 3.) Of particular interest for the control techniques disclosed herein are a mass air flow (MAF) sensor 84 located in the intake passage upstream of the turbocharger subsystem as shown in FIG. 3, and an intake O₂ sensor 86 located in or near the intake manifold 34 as shown in FIG. 3. Use of an O₂ sensor 86 in or near the intake manifold provides direct measurement of O₂ mole fraction in the premixed charge, i.e., oxygen content from both fresh air and recirculated exhaust gases. Measurement or estimation of EGR flow or FOR fraction therefore is not required, hence eliminating the need for an FOR mass flow sensor or other mechanisms thr measuring or estimating EGR flow. In the alternative, the intake O₂ sensor 86 could be eliminated, and the O₂ mole fraction in the premixed charge could be calculated from a measured or determined EGR fraction or EGR mass flow rate and a measured or estimated O₂ exhaust concentration.

Other sensors, such as an FOR temperature sensor, an ambient pressure sensor, an ambient temperature sensor, a humidity sensor, and/or a vehicle speed sensor may be provided as well. These sensors are collectively denoted “other sensor(s)” 88 in FIG. 4 and are connected to the gaseous fuel controller 70 by appropriate signal line(s). Still other sensors that are needed only when the engine 10 is operating m diesel-only mode are denoted as 92 and connected to the liquid fuel controller 72. One or more of these sensors alternatively could be connected to the gaseous fuel controller 70, in which case the information contained therein would simply be relayed in an unmodified fashion to the liquid fuel controller 72 via the CAN link 74. The gaseous fuel controller 70 also is connected to the gas metering device 40, and to other controlled equipment, such as high-pressure and/or low pressure gas shut off valves, denoted by reference numeral 90. (If the engine were a multipoint engine in which an individual gas fuel injector was assigned to each cylinder, those injectors would be controlled by the gaseous fuel controller 70 in lieu of the controlling metering device 40. The liquid fuel controller 72 is connected to each of the injectors 50. It could also control other components of the engine, as denoted by reference numeral 94.

The gaseous fuel controller 70 may be operable to control the liquid fuel controller 72 in a master-slave relationship so as to cause the liquid fuel controller 72 to control the fuel injectors 50 to inject pilot fuel into the cylinders 12₁-12₆ at a timing and quantity that achieve the desired effect at prevailing speed and load conditions. This control need not be with feedback from the liquid fuel controller 72 to the gaseous fuel controller 70. It instead may be performed by intercepting signals that, in an OEM engine, would have been bound for the liquid fuel controller 72 and modifying those signals to effect pilot fuel injection for multi-fuel operation rather than diesel-only injection for diesel-only operation. Alternatively, signals outbound from the liquid fuel controller 72 could be intercepted and modified by the gaseous fuel controller 70 before being transmitted to the diesel injectors. However, in the preferred embodiment in which the liquid fuel controller 72 and gaseous fuel controller 70 are connected to one another by a CAN-link or other broadband communications link 74, more sophisticated communications occur between the controllers 70 and 72. The use of a broadband communications link to facilitation operation of a multimode engine is described in U.S. Pat. No. 6,694,242, the contents of which are incorporated herein by reference. One or both of the controllers 70 and 72 could also be linked to additional controllers, such as a vehicle controller that controls other aspects of vehicle operation, by the CAN-link.

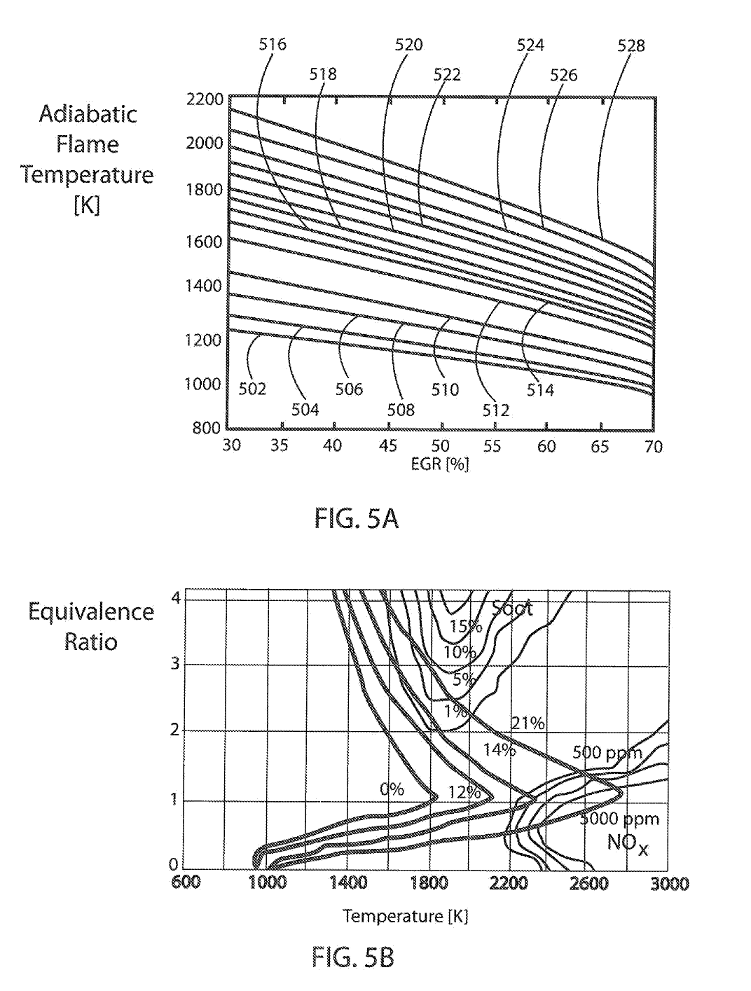

Preferably, EGR and fresh air λ are controlled so as to maintain a peak in-cylinder temperature of between 1500 K-2000 K and a local λ, i.e, a λ at any given location in cylinder, over 1.0. It has been discovered that the maximum flame temperature can be maintained within this range by maintaining EGR between 45% and 50%, and by keeping local λ between 1.3 and 1.6. These results are verified graphically by the curves 502-528, as found in FIG. 5A, which plot peak in-cylinder temperature vs. EGR for various lambdas as identified in Table 1:

TABLE 1
LAMBDA CORRELATION CURVES

| CURVE | LAMBDA |
|---|---|
| 502 | 1.0 |
| 504 | 1.1 |
| 506 | 1.2 |
| 508 | 1.3 |
| 510 | 1.4 |
| 512 | 1.5 |
| 514 | 1.6 |
| 516 | 1.7 |
| 518 | 1.8 |
| 520 | 2.0 |
| 522 | 2.5 |
| 524 | 3.0 |
| 526 | 3.5 |
| 528 | 4.0 |

Within this same local lambda range of 1.3 and 1.6, peak in-cylinder temperature can also be maintained in the 1500 K-2000 K range by keeping O₂ mole fraction in the ratio at 13%-14% as shown in FIG. 5B. It should be noted that boost pressure is the sum of partial pressures due to fresh air, EGR, and gaseous fuel. In addition, EGR, boost pressure, λ, and O₂ interact with each other at a given engine load. For example, boost pressure, λ, and O₂ all decrease with increases in EGR. It also should also be noted that EGR is limited under given operating conditions by the available intake pressure and the exhaust gas pressure. When EGR valve 102 is held constant while boost pressure is increased, fresh air λ increases, increasing in-cylinder O₂ mole fraction.

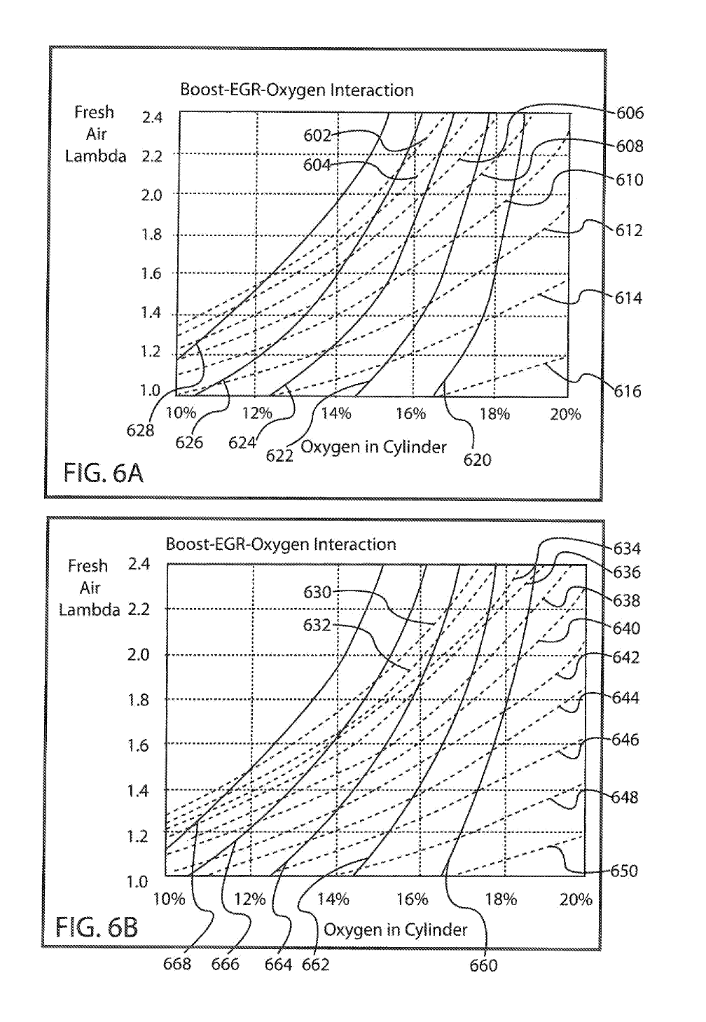

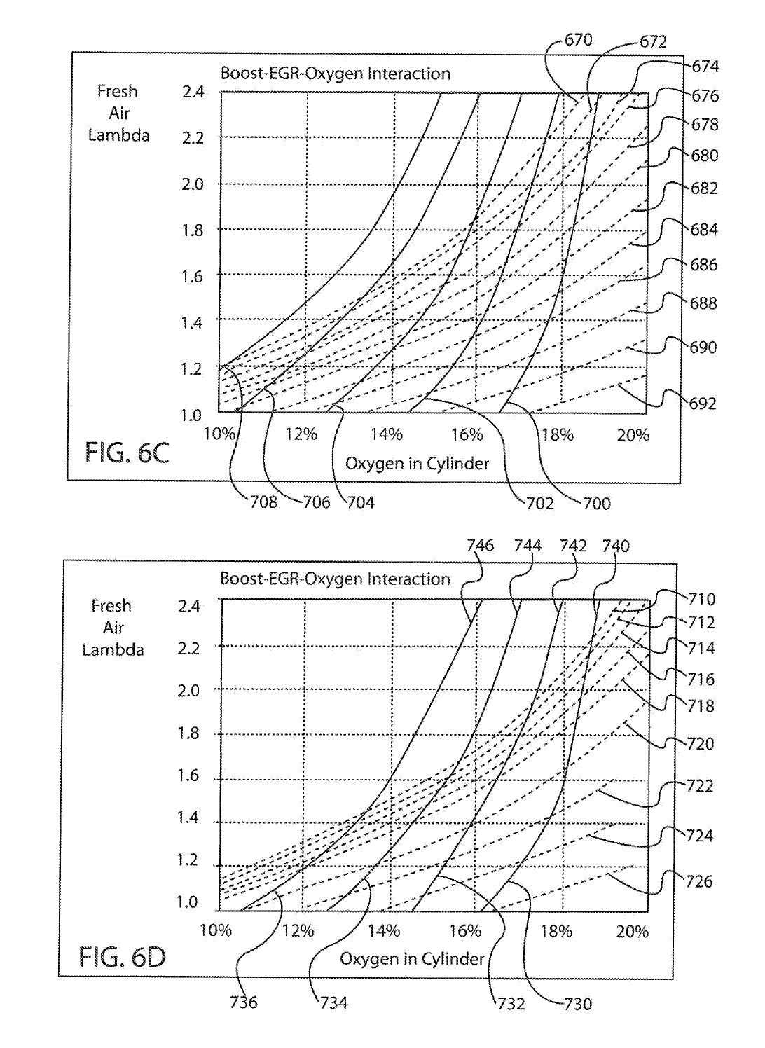

The effects of changes in EGR and boost pressure, as measured in terms of MAP, on fresh air λ and O₂ mole fraction are illustrated in FIGS. 6A-6D. All simulations assume a volumetric efficiency of 95%, a combustion efficiency of 100%, an ambient temperature of 30° C., and a relative humidity of 30%. The graphs of FIG. 6A illustrate simulation results of an engine at a 25% load having a fuel mix of 34 mg diesel and 32 mg CH4. Curves 602-616 reflect the results for MAPs of 2.0 bar, 1.8 bar, 1.6 bar, 1.4 bar, 1.2 bar, 1.0 bar, 0.8 bar, and 0.6 bar, respectively. Curves 620-628 reflect results for EGRs of 20%, 30%, 40%, 50%, and 60%, respectively. The graphs of FIG. 6B illustrate simulation results of an engine at a 50% load having a fuel mix of 30 mg diesel and 78 mg CH4. Curves 630-650 reflect the results for MAPS of 3.0 bar, 2.8 bar, 2.6 bar, 2.4 bar, 2.2 bar, 2.0 bar, 1.8 bar, 1.6 bar, 1.4 bar, 1.2 bar, and 1.0 bar, respectively. Curves 660-668 reflect results for EGRs of 20%, 30%, 40%, 50%, and 60%, respectively. The graphs of FIG. 6C illustrate simulation results of an engine at a 75% load having a fuel mix of 44 mg diesel and 109 mg CH4. Curves 670-692 reflect the results for MAPS of 3.6 bar, 3.4 bar, 3.2 bar, 3.0 bar, 2.8 bar, 2.6 bar, 2.4 bar, 2.2 bar, 2.0 bar, 1.8 bar, 1.6 bar, and 1.4 bar, respectively. Curves 700-708 reflect results for EGRs of 20%, 30%, 40%, 50%, and 60%, respectively. The graphs of FIG. 6D illustrate simulation results of an engine at a 100% load having a fuel mix of 81 mg diesel and 132 mg CH4. Curves 710-726 reflect the results for MAPS of 4.4 bar, 4.2 bar, 4.0 bar, 3.8 bar, 3.6 bar, 3.2 bar, 2.8 bar, 2.4 bar, and 2.0 bar, respectively. Curves 740-746 reflect results for EGRs of 20%, 30%, 40%, and 50%, respectively.

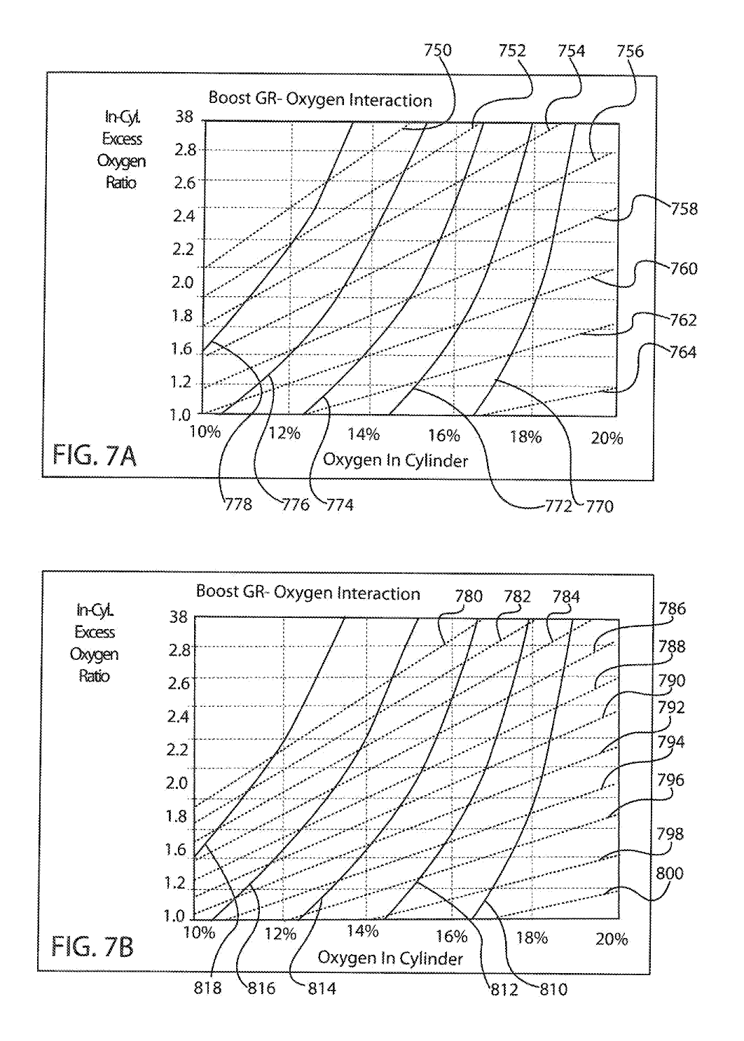

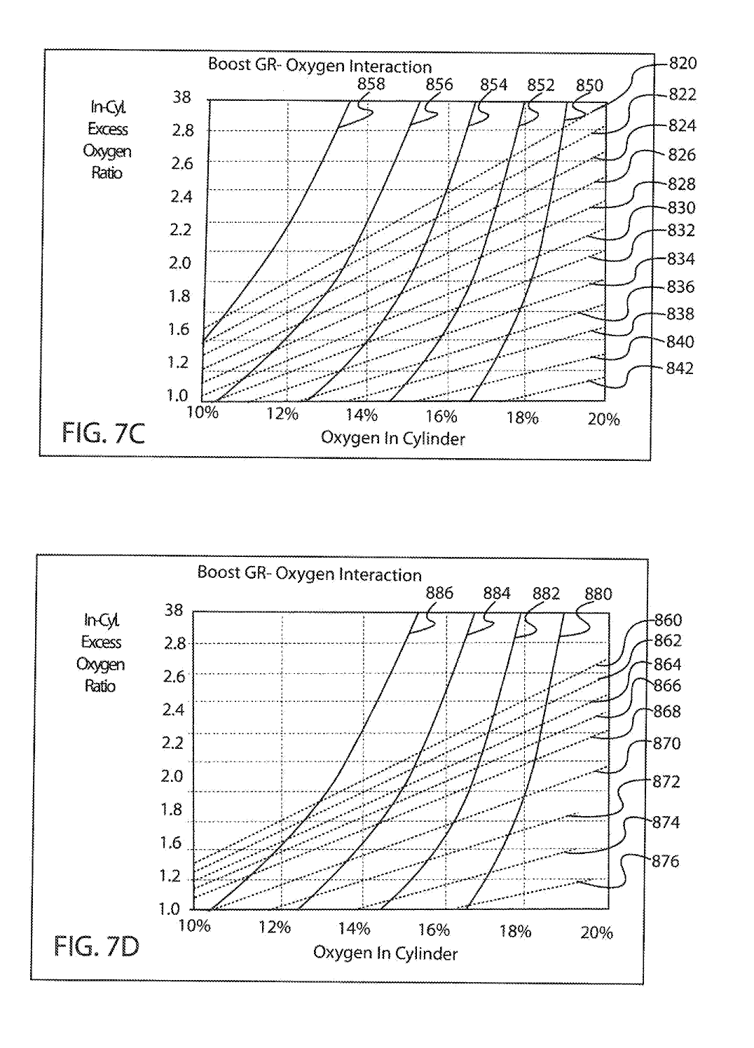

The effects of changes in EGR and boost pressure, as measured in MAP, on in cylinder excess oxygen ratio and O₂ mole fraction are illustrated in FIGS. 7A-7D. All simulations assume a volumetric efficiency of 95%, a combustion efficiency of 100%, an ambient temperature of 30° C., and a relative humidity of 30%. The graphs of FIG. 7A illustrate simulation results of an engine at a 25% load having a fuel mix of 34 mg diesel and 32 mg CH4. Curves 750-764 reflect the results for MAPS of 2.0 bar, 1.8 bar, 1.6 bar, 1.4 bar, 1.2 bar, 1.0 bar, 0.8 bar, and 0.6 bar, respectively. Curves 770-778 reflect the results for EGRs of 20%, 30%, 40%, 50%, and 60%, respectively. The graphs of FIG. 7B illustrate simulation results of an engine at a 50% load having a fuel mix of 30 mg diesel and 78 mg CH4. Curves 780-800 reflect the results for MAPS of 3.0 bar, 2.8 bar, 2.6 bar, 2.4 bar, 2.2 bar, 2.0 bar, 1.8 bar, 1.6 bar, 1.4 bar, 1.2 bar, and 1.0 bar, respectively. Curves 810-818 reflect the results for EGRs of 20%, 30%, 40%, 50%, and 60%, respectively. The graphs of FIG. 7C illustrate simulation results of an engine at a 75% load having a fuel mix of 44 mg diesel and 109 mg CH4. Curves 820-842 reflect the results for MAPS of 3.6 bar, 3.4 bar, 3.2 bar, 3.0 bar, 2.8 bar, 2.6 bar, 2.4 bar, 2.2 bar, 2.0 bar, 1.8 bar, 1.6 bar, and 1.4 bar, respectively. Curves 850-858 reflect the results for EGRs of 20%, 30%, 40%, 50%, and 60%, respectively. The graphs of FIG. 7D illustrate simulation results of an engine at a 100% load having a fuel mix of 81 mg diesel and 132 mg CH4. Curves 860-876 reflect the results for MAPS of 4.4 bar, 4.2 bar, 4.0 bar, 3.8 bar, 3.6 bar, 3.2 bar, 2.8 bar, 2.4 bar, and 2.0 bar, respectively. Curves 880-886 reflect the results of EGRs of 20%, 30%, 40%, and 50%, respectively.

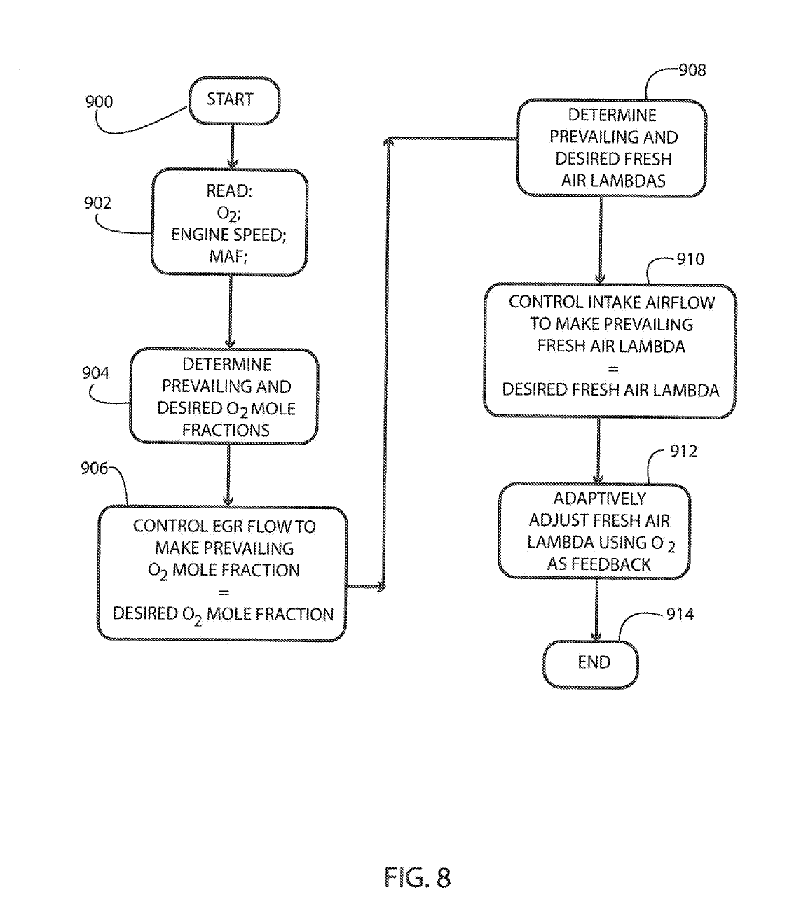

Turning now to FIG. 8, a process for facilitating low temperature combustion in engine 10 based on a targeted oxygen content and a targeted in-cylinder fresh air λ is shown as beginning at START in Block 900. This process typically will be executed by the gaseous fuel controller 70, but conceivably could be executed in whole or in part by the liquid fuel controller 72 or another controller entirely. A prevailing intake O₂ concentration, obtained from sensor 86, is read in Block 902. Engine speed and mass air flow (MAF) are also read or determined at this time.

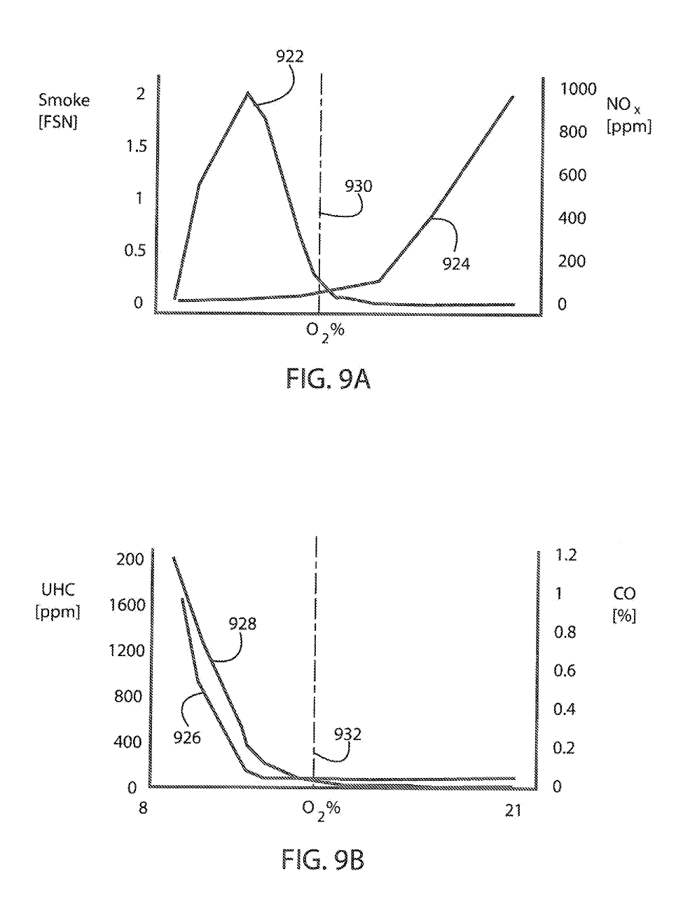

The desired in-cylinder or intake O₂ mole fraction is then determined in Block 904. The benefits of determining the desired O₂ mole fraction value can be appreciated from a theoretical standpoint with reference to the curve 922 FIG. 9A, which shows that, at any give speed and total fuel quantity, soot (particulates) decreases very rapidly after an initial peak with increasing O₂ concentration. Conversely, curve 924 demonstrates that s NOx emissions increase very rapidly after O₂ levels reach a threshold value. Referring to the curves 926 and 928 in FIG. 9B, UnburnHC and CO emissions increase very rapidly when O₂ concentration drops below a threshold level. In the illustrated embodiment, all of these emissions are minimized when in-cylinder O₂ mole fraction is maintained within the range of 13-14% as illustrated by the vertical lines 930 and 932 in FIGS. 9A and 9B, respectively. This can be considered the desired in-cylinder O₂ mole fraction for this example. That value may be remain the same for all operating conditions in less sophisticated systems, or may be optimized and mapped for a full range of speed and total fuel content operating conditions in more sophisticated systems.

Referring again to FIG. 8, using information from the intake manifold O₂ sensor 86 (FIGS. 3 and 4), a determination of prevailing in-cylinder O₂ mole fraction also is made in Block 904. Using this determined in-cylinder O₂ mole fraction, the EGR valve 102 of FIG. 3 is controlled to achieve the desired in-cylinder O₂ mole fraction in Block 906. This control could be performed on either an open loop or closed loop control basis. Some possible control strategies are described, for example, in U.S. Pat. No. 6,948,475, the contents of which are hereby incorporated by reference. The control system 12 then regulates the EGR valve 102 in Block 906 to achieve the target in-cylinder O₂ mole fraction, with that regulation resulting in adjustment of the partial pressures of air and EGR. This regulation results in a change in boost pressure due to the partial pressure of air in the cylinder.

As discussed above, system 12 also is configured to optimize or regulate a fresh air λ. This regulation begins in Block 908 of FIG. 8 based on air flow data received from MAF sensor 84 of FIG. 3. The prevailing fresh air λ may be calculated in the Block according to the formula:

$${λ}_{FreshAir} = \frac{FreshAirFlow}{LiqudFlow * {SAFR}_{Liqud} + GasFlow * {SAFR}_{Gas}} ;$$

### Where:

λ_{FreshAir}=the current fresh air lambda;

FreshAirFlow=the fresh air flow rate to each cylinder in g/sec.;

LiquidFlow=the flow rate of liquid fuel to each cylinder in g/sec.;

SAFR_{Liquid}=the stochiometric air fuel ratio (in mass) of the liquid fuel. SAFR_{Liquid} typically is 14.5 for diesel fuel;

GasFlow=the flow rate of gaseous fuel to each cylinder in g/sec.; and

SAFR_{Gas}=the stochiometric air fuel ratio (in mass) of the gaseous fuel. SAFR_{Gas} varies with gaseous fuel composition but can be considered 16.4 on average for natural Gas

The desired fresh air λ may be determined at this time based on at least the MAF sensor input, the current engine speed, and the total fuel amount. According to an exemplary embodiment, the desired fresh air λ is within the range of 1.2-1.3%.

Next, in Block 910 of FIG. 8, intake airflow is adjusted to make the actual fresh air λ equal the desired fresh air λ. This adjustment may involve controlling the TAB valve 130, the wastegate 132, and/or the air intake valve 134 (throttle valve). The control may be either open loop or closed loop. It should be noted that not all of these devices need be present in any particular system and that, even if they are all present, not all of these devices will be controlled under some operating conditions.

For example, the wastegate valve, TAB valve, and throttle valve could be controlled sequentially or in a cascading order in which each successive device in the chain is controlled only when the preceding device in the chain is at a maximum position 1.0 and still additional airflow adjustment is required. If such a cascading or sequential control is implemented, it need not be implemented in the order presented herein.

Next, in Block 912, the desired fresh air λ may be adaptively adjusted using exhaust O₂ as a feedback of O₂. A method for such adaptive control is described in U.S. patent application Ser. No. 12/877,487, the entirety of which is hereby incorporated by reference. The process then proceeds to return at Block 914.

To the extent that they might not be apparent from the above, the scope of variations falling within the scope of the present invention will become apparent from the appended claims.

We claim:

1. A method of fueling an internal combustion engine, the method comprising:
(A) operating the internal combustion engine in a mode in which the engine is fueled by a pre-mixed charge of gaseous fuel, fresh air, recirculated exhaust gases and a liquid fuel; and
(B) controlling at least one of EGR flow and fresh air flow to the engine so as to maintain a peak in-cylinder temperature in a desired range.

2. The method of claim 1, wherein the desired range is between 1500 K and 2000 K.

3. The method of claim 1, wherein the controlling step comprises
i. controlling EGR flow to each engine cylinder to obtain a desired in-cylinder O₂ mole fraction, and
ii. controlling fresh air flow to each engine cylinder to obtain a desired fresh air lambda.

4. The method of claim 3, wherein the desired fresh air lambda is between 1.2 and 1.3.

5. The method of claim 3, wherein the desired in-cylinder O₂ mole fraction is between 13% and 14%.

6. The method of claim 3, further comprising determining a current in-cylinder O₂ mole fraction based on measurement data from an O₂ sensor in an intake manifold of the internal combustion engine.

7. The method of claim 6, wherein the determined in-cylinder O₂ mole fraction is dependent on at least one of engine speed and total fuel.

8. The method of claim 1, wherein the step of controlling fresh air flow comprises controlling at least one of a turbo wastegate, a turbo-air-bypass, and an inlet throttle.

9. The method of claim 1, wherein the step of controlling fresh air flow comprises controlling a combination of two or more of a wastegate valve, a turbo-air-bypass valve, and a throttle valve in a cascading order in which each successive device is controlled only when the preceding device is adjusted to a maximum available extent and additional airflow adjustment is required.

10. The method of claim 3, wherein a prevailing fresh air lambda is determined using data from a mass air flow sensor.

11. The method of claim 10, wherein the current fresh air lambda is calculated according to the formula:
$${λ}_{FreshAir} = \frac{FreshAirFlow}{LiqudFlow * {SAFR}_{Liqud} + GasFlow * {SAFR}_{Gas}} ;$$
where:
λ_{FreshAir}=the current fresh air lambda;
FreshAirFlow=the fresh air flow rate to each cylinder in g/sec.;
LiquidFlow=the flow rate of liquid fuel to each cylinder in g/sec.;
SAFR_{Liquid}=the stochiometric air fuel ratio (in mass) of the liquid fuel;
GasFlow=the flow rate of gaseous fuel to each cylinder in g/sec.; and
SAFR_{Gas}=the stochiometric air fuel ratio (in mass) of the gaseous fuel;

12. A method of fueling an internal combustion engine, the method comprising:
(A) operating the internal combustion engine in a mode in which the engine is fueled by a pre-mixed charge of gaseous fuel, fresh air, recirculated exhaust gases and a liquid fuel;
(B) controlling FOR flow to each engine cylinder to obtain a desired in-cylinder O₂ mole fraction, and
(C) controlling fresh air flow to each cylinder to obtain a desired fresh air lambda.

13. The method of claim 12, wherein the controlling step maintains a peak in-cylinder temperature between 1500 K and 2000 K.

14. A method of controlling combustion temperature in an internal combustion engine fueled by a premixed charge of fresh air, recirculated exhaust gases and a gaseous fuel as primary fuel and early injected diesel as a secondary fuel so as to maintain a peak in-cylinder temperature between 1500 K and 2000 K, the method comprising, for each cylinder:
(A) determining a desired in-cylinder O₂ mole fraction based on engine speed and total fuel;
(B) determining a current in-cylinder O₂ mole fraction;
(C) modifying the current in-cylinder O₂ to match the desired in-cylinder O₂, the modifying step including adjusting EGR flow to the associated cylinder;
(D) determining a desired fresh air lambda based on engine speed and total fuel;
(E) determining a current fresh air lambda; and
(F) adjusting airflow to the cylinder to modify the current fresh air lambda to match the desired fresh air lambda.

15. An internal combustion engine, the engine comprising:
(A) a plurality of cylinders;
(B) a gaseous fuel delivery system that delivers a selected volume of gaseous fuel to the cylinders;
(C) a liquid fuel delivery system that delivers a selected volume of liquid fuel to the cylinders;
(D) intake control system that controls the flow of fresh air and EGR to the cylinders; and
(E) at least one controller coupled to the gaseous fuel delivery system, the liquid fuel delivery system, and the air intake control system control at least one of EGR flow and fresh air flow to the engine so as to maintain a peak in-cylinder temperature within a desired range.

16. The internal combustion engine of claim 15, wherein the desired range is between 1500 K and 2000 K.

17. The internal combustion engine of claim 15, wherein the controller:
i. controls EGR flow to each engine cylinder to obtain a desired in-cylinder O₂ mole fraction, and
ii. controls fresh air flow to each cylinder to obtain a desired fresh air lambda.

18. The internal combustion engine of claim 15, wherein the intake control system includes at least one of a turbo wastegate, a turbo-air-bypass, and an inlet throttle.
